(19) United States
(12) Patent Application Publication
(10) Pub. No.: US 2020/0348899 A1
(43) Pub. Date: Nov. 5, 2020

(54) ARTIFICIAL INTELLIGENCE (AI) ENABLED MULTI-SCREEN VISUAL CUE RELAY SYSTEMS AND METHODS

(71) Applicant: NEC Laboratories Europe GmbH, Heidelberg (DE)

(72) Inventors: Ammar Shaker, Heidelberg (DE); Mischa Schmidt, Heidelberg (DE)

(21) Appl. No.: 16/398,395

(22) Filed: Apr. 30, 2019

(51) Int. Cl. G06F 3/14; H04N 21/431; H04N 21/485

(52) U.S. Cl. CPC G06F 3/1454; H04N 21/485; H04N 21/4312

(57) ABSTRACT

Systems and methods for simultaneously displaying an external visual cue received at a primary display device on one or more secondary display devices in a distributed presentation system. The method includes displaying original content on a primary display device, detecting an external visual cue on the displayed original content, determining one or more parameters of the external visual cue, the one or more parameters including at least a location of the external visual cue relative to, or on, the displayed original content, and communicating the one or more parameters to one or more secondary display devices that are displaying the original content, to enable the one or more secondary display devices to display a representation of the external visual cue simultaneously with displaying the original content.

### FIELD

The present invention relates to facilitating presentations involving multiple presentation display screens and, in particular, to systems and methods for communicating detected visual cues used by the presenter on one (main or primary) display screen to other (secondary) display screens for overlaying the detected cues.

### BACKGROUND

In presentations, e.g., in meetings or at conferences, despite using modern presentation software (e.g. Microsoft PowerPoint) and digital projection equipment, it is common that presenters use ad-hoc methods to draw the attention of the audience to parts of their presented material during their explanations.

In many presentation situations, for example where a large number of audience members may exist, in order to grant this audience the ability to visually observe the presented material, multiple projection surfaces and projectors, large screens and even hand-held devices may be used to simultaneously show or present the presenter's material. It is often the case that the presenter may annotate the content by highlighting some of the projected content on only one of the projected surfaces using a laser pointer, hence, leaving the audience that follows the other projected surfaces, monitors and other devices completely uninformed about his annotations.

This situation often occurs for example in large meeting rooms, or in meetings spread across multiple meeting rooms, in which multiple screens show the same presentation to the spread out audience. However, on the main stage, the presenter typically would use visual cues to explain aspects of the presentation. When not using the mouse of the computer to interact with the presentation software for providing visual cues (which are then broadcast to all connected screens), the typical visual cues are, e.g. poles, telescope poles, or laser pointing devices. These are then typically only visible on the projection area the presenter points to (i.e. “main screen”). The audience following on the other projection areas (“secondary screens”) do not receive the visual cues and thus may have a sub-optimal presentation experience.

### SUMMARY

In an embodiment, a method is provided for simultaneously displaying an external visual cue received at a primary display device on one or more secondary display devices in a distributed presentation system. The method includes displaying original content on a primary display device, detecting an external visual cue on the displayed original content, determining one or more parameters of the external visual cue, the one or more parameters including at least a location of the external visual cue relative to, or on, the displayed original content, and communicating the one or more parameters to one or more secondary display devices that are displaying the original content, to enable the one or more secondary display devices to display a representation of the external visual cue simultaneously with displaying the original content.

### BRIEF DESCRIPTION OF THE DRAWINGS

Embodiments of the present invention will be described in greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows an example presentation system architecture according to an embodiment.

FIG. 2 illustrates a method of simultaneously displaying an external visual cue received at a primary display device on one or more secondary display devices in a distributed presentation system, according to an embodiment.

### DETAILED DESCRIPTION

According to embodiments, systems and methods are provided for facilitating presentations involving multiple presentation display screens or display devices. According to embodiments, systems and methods are provided for the detection and location of external visual cues (e.g., laser pointer(s), pointing devices, etc.) used by humans to highlight aspects when viewing content on a projection device (e.g., PowerPoint presentation, video, etc.). After characterizing a detected cue in terms of position, color and/or shape, the presence of the cue is communicated to multiple (secondary) projection devices for overlaying corresponding cues in these secondary devices without changing the content stream from a content source (e.g. presentation laptop) to the projection devices

In an embodiment, a distributed presentation system for simultaneously displaying a visual cue received at a primary display device on one or more secondary display devices is provided. The presentation system includes a primary display device that displays original content from a content source, a camera paired with the primary display device and configured to record the original content displayed by the primary display device, one or more secondary display devices, each of the one or more secondary display devices displaying the original content, and a processing component in communication with the camera and the content source. The processing component is configured to receive the recorded original content from the camera, process the recorded original content to detect an external visual cue on the original content displayed by the primary display device and determine one or more parameters of the external visual cue, the one or more parameters including at least a location of the external visual cue relative to, or on, the original content displayed by the primary display device, and communicate the one or more parameters to the one or more secondary display devices that are displaying the original content, wherein the one or more secondary display devices display a representation of the external visual cue simultaneously with displaying the original content.

In an embodiment, a method is provided for simultaneously displaying an external visual cue received at a primary display device on one or more secondary display devices in a distributed presentation system. The method includes displaying original content on a primary display device, detecting an external visual cue on the displayed original content, determining one or more parameters of the external visual cue, the one or more parameters including at least a location of the external visual cue relative to, or on, the displayed original content, and communicating the one or more parameters to one or more secondary display devices that are displaying the original content, to enable the one or more secondary display devices to display a representation of the external visual cue simultaneously with displaying the original content.

In an embodiment, the one or more parameters further include one or more of a color of the external visual cue and a shape of the external visual cue.

In an embodiment, at least one of the one or more secondary display devices is located in a location remote from the primary display device.

In an embodiment, the communicating includes communicating the one or more parameters to the at least one secondary device over the Internet or a wireless network.

In an embodiment, the method further includes communicating a cue identifier with the one or more parameters, wherein the cue identifier identifies the primary display device on which the external visual cue was detected.

In an embodiment, the detecting includes detecting a first appearance of the external visual cue and detecting movements of the external visual cue on the displayed original content.

In an embodiment, information regarding the detected movements of the external visual cue are communicated to the one or more secondary display devices when the detected movements are larger than a preset sensitivity threshold.

In an embodiment, the detecting includes acquiring an image of a display screen of the primary display device, wherein the external visual cue is overlaying the displayed original content on the display screen, and comparing the acquired image with the original content to identify the external visual cue.

In an embodiment, the method further includes receiving one or more parameters of a second external visual cue from one of the one or more secondary display devices, the one or more parameters of the second external visual cue including at least a location of the second external visual cue relative to the displayed original content, and displaying a representation of the second external visual cue over the original content displayed by the primary display device.

According to embodiments, multiple projection areas (“screens”) that all should show the same presentation, e.g. to a large audience in a big conference room. At least one camera is paired with a main projection surface, i.e. the surface onto which the presenter will use visual cues for presentation. A detection module processes the camera's data and searches for visual cues by the presenter. When detected, the visual cue's coordinates relative to the main projector are calculated. Information about the visual cue and its relative coordinates is communicated to the secondary display devices in the presentation system. These secondary devices may reproduce the visual cues in the relative coordinates on top of the presentation they project.

In an embodiment, a visual cue detection and characterization component is provided for use in a distributed presentation system that includes a primary display device that displays original content from a content source, a camera paired with the primary display device and configured to record the original content displayed by the primary display device, and one or more secondary display devices, each of the one or more secondary display devices displaying the original content. The visual cue detection and characterization component includes one or more processors and a transceiver, wherein the visual cue detection and characterization component is configured to receive, using the transceiver, the recorded original content from the camera, process, using the one or more processors, the recorded original content to detect an external visual cue on the original content displayed by the primary display device and determine one or more parameters of the external visual cue, the one or more parameters including at least a location of the external visual cue relative to the original content displayed by the primary display device, and communicate, using the transceiver, the one or more parameters to the one or more secondary display devices that are displaying the original content, to enable the one or more secondary display devices to display a representation of the external visual cue simultaneously with displaying the original content.

In an embodiment, the one or more processors detect an external visual cue by comparing an image of a display screen of the primary display device with the original content to identify the external visual cue, wherein the external visual cue is overlaying the displayed original content on the display screen

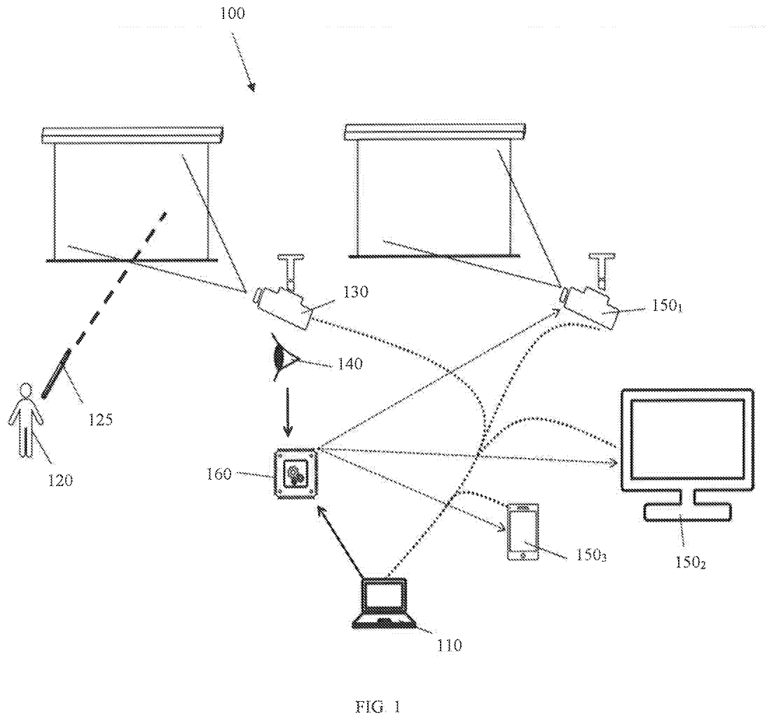

FIG. 1 illustrates a distributed presentation system 100 according to an embodiment. Presentation system 100 includes a primary display device 130 that displays content from a source device 110, and one or more secondary display devices 150 (e.g., slave devices) that also display the same content provided by source device 110. The secondary display device(s) 150 may be located in the same room or hall as the primary display device 130 and/or in one or more locations remote from the primary display device 130 (and content source 110). For example, one secondary display device 150 may be located in a different room within the same building or complex as primary display device 130 and/or another secondary display device 150 may be located in a different geographical location, for example, a location in a different time zone, than primary display device 130.

In an embodiment, to facilitate a pointer (object)-aware projection, system 100 detects one or more external visual display cues using a camera 140 or other detection device. A display cue may include a foreign object on, or interacting with, the projection surface or display surface of the primary presentation device 130. An example is a spot created by a laser pointer. When a cue has been detected, the cue is characterized to determine information such as the location on the display surface. This information is communicated to other, secondary display devices 150 that also display the same original content before the altering caused by the detected object or interaction.

Source device 110 may include a personal computer, laptop, tablet, hand-held device, or other device capable of interpreting and/or manipulating digital data, such as a presentation file (e.g., PowerPoint, Word, Keynote, Adobe, etc.) or other media content (e.g., video, images, etc.), that is to be projected for, or displayed to, the audience viewing a primary display device 130 and one or more secondary display device(s) 150. The primary display device 130, and the secondary display devices 150 may include a projector, a monitor, hand-held devices or other devices capable of displaying the content provided by content source 110. For example, as shown in FIG. 1, in an embodiment, primary display device 130 includes a projector and associated display screen or surface, secondary display device 1501 includes a projector and associated display screen or surface, secondary display device 1502 includes a monitor or television screen, and secondary display device 1503 includes a hand-held device such as a smart phone or tablet. Each display device 130, 150 receives the data content from source device 110 and projects the data content onto the display surface in the case of a projector, or displays the data content on a display screen in the case of a monitor or hand-held device.

In FIG. 1, the actor or presenter 120 may control the source device 110, and narrates the presentation while reading/discussing and pointing at or highlighting elements of the projected data content using pointing element 125. Pointing element 125 may include a laser pointer or other pointing device or implement, including a finger, which provides visual display cues or hints or otherwise draws the audience's attention to a sub-region of the displayed data content.

Camera 140 operates to record the displayed (e.g., projected) content by observing the projection surface or display surface of primary display device 130. The recorded data (e.g., images) are communicated in real-time to detection component 160. The original data content displayed by primary display device 130 is also provided to detection component 160, e.g., by source device 110, or by primary display device 130. Detection component (or detection module) 160 includes one or more processors, and associated memory, that execute a detection and characterization algorithm (“detection algorithm”) to process the received recorded data to determine whether a foreign object is detected on, or interacting with, the original displayed content. For example, the detection algorithm may detect a foreign object as a result of inference and decide based on the original content data and the recording of original data's projection on the projection surface, and their difference, whether there is a foreign object intentionally introduced by the actor or not. In certain embodiments, the detection algorithm is a deployed model that is trained using machine learning approaches on image data. In an embodiment, detection component 160 is a stand-alone device in communication with camera 140 and source device 110. In another embodiment, detection component 160 may be integrated with camera 140 and/or with source device 110. In an embodiment, the camera 140 and the detection module 160 are integrated with the main display device 130, e.g. when a projector is used.

The various system components each include a transmitting and receiving component, e.g., a hardware transceiver running appropriate protocols, which allows the various components to communicate. For example, using a transceiver, information such as the position, shape and/or color of the detected visual cue may be sent from the primary display device 130 or detection component 160 to the secondary display devices 150. Similarly, using a transceiver, the visual cue information may be received at a secondary devices 150. In an embodiment, the various system components may communicate using one or more communication capabilities, e.g., wireless, Bluetooth, Ethernet, cellular data connections or any other communication technologies, e.g., using FTP, TCP/IP, WLAN, etc. A secondary display device may also be presenting to the audience at a remote location that is reachable over the Internet.

In an embodiment, only the cue position is transmitted (if detected). The secondary device(s) may then present a pre-configured visual cue shape and/or color at the received position. In an embodiment, the shape of the detected object or visual cue and its color (or a segmented image of the visual cue) may be sent to the secondary display device(s) 150.

In certain embodiments, the information about the cue is transmitted to the secondary display devices 150 throughout the time period that the visual cue is detected. The secondary display devices 150 may display the cue as they receive the cue information.

In certain embodiments, timing is discrete, i.e. the detection module is run in configurable time intervals (e.g. every 1/25 s) and data is transmitted each time the module detects a cue. In this case, the time interval may correspond to how long the secondary screens may present the visual cue after receiving the cue information.

In certain embodiments, appearance and disappearance of visual cues are detected as events. In this case, there may be different message types to be used in relation to visual cues.

In certain embodiments, the detection of a visual cue identifies information about the cue. Such information may include parameters such as the relative position of the cue on the primary display screen and optionally the color and/or shape of the visual cue. When received by the secondary display device(s), each secondary display device may overlay a representation of the cue at the indicated relative position. In an embodiment, an internal cue identifier (ID) is associated with the event to avoid ambiguity in embodiments where multiple cues are supported, e.g., two or more visual cues detected on a primary display device and/or two or more visual cues detected on two or more primary display devices.

In an embodiment, the detection module can track a detected cue's movement on the main screen. If movement is detected, position information may be sent to the secondary display devices only, e.g., the position where the cue moved to (e.g., omitting the color and shape information). In case multiple markers are supported, the internal cue id is communicated to the secondary display devices to prevent ambiguity.

To minimize cue related traffic e.g. due to the presenter's slight hand shaking when pointing with a laser pointer, the detection module 160 may be configured with a sensitivity threshold; movements smaller than the threshold compared to the last detection position may then not be transmitted.

In an embodiment, when the detection module is not able to detect a previously detected cue, the secondary display devices may be instructed to remove the previously detected cue.

It is advantageous that the detection module has access to the presented content data, i.e. the content being displayed at the primary display device. For example, the detection module may subtract the presentation data from the camera data to filter out most of the content except noise.

In an embodiment, the detection module is calibrated to the main display device display screen, e.g. by a test image being projected and recorded by the camera. This may help to correct for potential distortions and help detection quality.

In certain embodiments, multiple display devices may be equipped with a camera 140 and a detection module (or they may share a single detection module 160), and different cues at the different display device screens can be detected and relayed simultaneously. Thus, situations are supported, e.g., when multiple people use laser pointers on the display screen closest to them, these are then relayed to all devices for the benefit for the entire audience. This may be implemented, e.g., using a wide area network, and enables very user friendly multi-site remote collaboration using laser pointers or other visual cue devices 125.

In an embodiment, a camera 140 may be mounted on a computer laptop or may be implemented as a smart phone camera to capture the main display screen. In this case, software (or an app) may run the detection module 160. Prior calibration may be implemented for optimal detection. This embodiment is advantageous, e.g., for situations when a meeting is taking place in multiple meeting rooms, and each room is only equipped with a standard projection device. In these cases, when someone uses a visual cue, the detection module can detect a cue and the cue may be relayed to a remote location. In an embodiment, two sides of a remote meeting may be equipped with such processing capability and a web camera to enable a two-way visual cue.

In an embodiment, the detection module 160 uses computer vision techniques to detect visual cues in the camera image. The detection module may correct for distortions using calibration data to determine an undistorted image. The detection module has access to the image(s) being projected to calculate the differences from the camera image (“difference image”). In a particular embodiment, e.g. the images are preprocessed, e.g., with the open source openCV library. In another embodiment, deep neural networks (e.g. convolutional neural networks) or other learning modalities, are applied to the camera image, the undistorted image, and/or the difference image to detect visual cues.

In an embodiment, the detection module 160 is pre-trained to detect typical colors and shapes of visual cues (e.g., laser pointers).

In an embodiment, the detection module 160 is trained to detect the presenter's visual cue of choice. This may be done by the detection module instructing the main screen to project a calibration image with an indicated area in which the visual cue of choice is to be pointed (e.g., the tip of a pointing pole, or the finger of the presenter). The detection module will then train a detector based on the acquired camera data.

In an embodiment, the image data is uploaded via a communication network to a computer or a cloud to train a deep neural network to detect the visual cue. The detected information may be transferred via the communication network to the detection module to be processed in the detection module.

In an embodiment, the detection module 160 is configured to run multiple detection components (e.g. multiple neural networks) in parallel. This modularity allows for an easy upgrade and exchange of detection modules.

In an embodiment, e.g., when using pointing sticks or the presenter's hand as visual cue implements (instead of laser pointers) a vision system capable of 3D imaging is used for reliable cue detection. The cue detection component may be trained on the 3D imaging data and a projection of positions in 3D space onto the content to be displayed is calculated by standard computer vision/graphics tools. This position information may be transmitted to the secondary display devices.

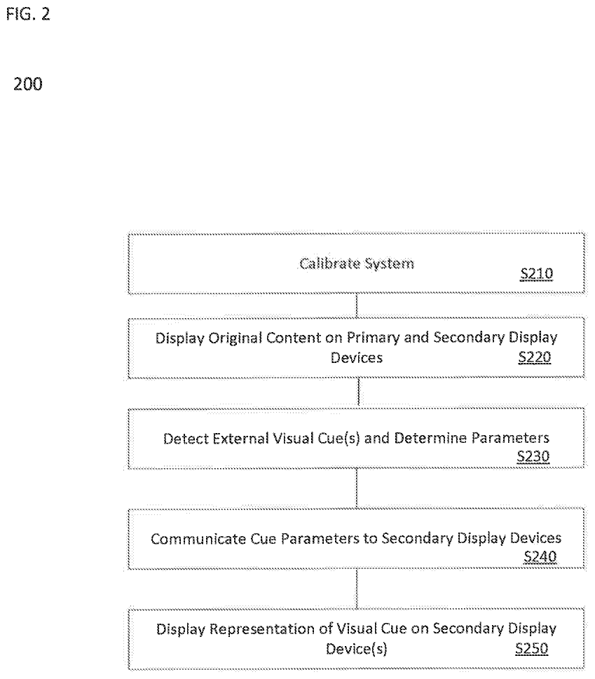

FIG. 2 schematically illustrates a method 200 of displaying an external visual cue received at a primary display device on one or more secondary display devices, according to an embodiment.

In optional Step S210, the system may be calibrated. For example, the detection component and algorithm may be calibrated to the environment in terms of the lighting conditions, projection surface and/or the pointing device interaction. Calibration may be beneficial to the overall performance of the system.

In step S220, original content is displayed on a primary display device and on one or more secondary display devices. For example, the original content from a source device may be projected in the case of a projection screen; the primary display device (Pm) projects the received original data onto the display surface (Sm), the remaining secondary devices (Ps1, . . . , Psd) project the same received original data onto the secondary surface(s) (Ss1, . . . , Ssd), respectively, and the actor discusses the projected material and controls its order, content using the source device.

In step S230, an external visual cue is detected on the displayed original content displayed by the primary display device and one or more object characteristics or parameters of the visual cue are determined. For example, the camera 140 records in a real time manner the displayed or projected content and sends the captured images to the detection component. The detection component observes both the source data (the data provided by, or broadcast by, the source device) and the captured images from the camera. In an embodiment, the detection may occur in the following order: 1) the captured image is calibrated back to the size and scale of the original data, 2) optionally for enhanced detection performance, the difference between the two images (original and captured) is computed; this results in creating the delta-image, 3) optionally for enhanced detection performance, the original image (or the delta-image) undergoes a number of preprocessing steps such as (1) de-noising, (2) sharpening and (3) contrast improvement, 4) a set of important features is generated and extracted from the processed original image (or the processed delta-image), creating a feature vector X (in a variant, the image is treated as a feature vector), 5) the feature vector is used as an input to the trained and deployed machine learning model on the detection component, and 6) the trained model detects the object(s) of interest, and defines its (their) characteristics such as the position, color, and/or shape, and outputs these characteristics as one or more parameters of the detected object(s).

In step S240, the one or more parameters are communicated to one or more secondary display devices. For example, the detection component may inform some or all secondary devices about the detected object(s)—the visual cue(s)—and sends to each of them object information, including one or more parameters, for use in displaying a representation of the detected visual cue at the receiving secondary devices as an overlay on the original content being displayed.

In step S250, the secondary device(s) display the original data and a representation of the detected visual cue(s) based on the received object information simultaneously at the same position (optionally with the same color and/or shape). In an embodiment, the detected objects are calibrated to the scale and coordinates of the original data content. In some cases it may be necessary to translate the representation in order to be shown in each secondary device in the respective size. Calibrations and translation may be performed at each secondary display device, or by the detection component.

In an embodiment, the detection component 160 executes an object classification and localization algorithm to characterize the visual cue(s) and generate the one or more parameters. The following provides an example of a high-level pseudo code algorithm that will undistort the observed camera image, then calculate a delta image and de-noise the delta image. The denoised delta image is run through a pre-trained YOLO algorithm (denoted detectionYOLO):

Algorithm CueDetectAndLocalize( )

Assumes: prior camera calibration data, per-trained detectionYOLO

Input: imageProjected, cameraImage

Output: cue object location or none

normalizedCameraImage=Undistort(cameraImage, cameraCalibrationData)

deltaImage=normalizedCameraImage−imageProjected

deltaImage=denoise(deltaImage)

cue=detectionYOLO(deltaImage)

If cue
return cue

else
return None

The above Algorithm assumes a pre-trained detectionYOLO. In the following, an example of how the detection model may be learned and prepared before being deployed on the detection component is provided. It should be appreciated that one skilled in the art may skip and/or alter some steps and achieve acceptable performance.

A computer generates a large set of different digital visual data that are to be presented by the main display device. As known in the state of the art, common “data augmentation” techniques such as shearing, transposing, mirroring and translation operations can be beneficial for the training.

A robotic arm may be used with a variety of different visual cue types (such as laser pointers with different colors, a pointing stick, etc.) that mimics the behavior of a human actor interacting with the primary display—possibly pointing at random positions at random times. The information of where the robotic arm pointed to is recorded.

Multiple projector types may be used to present content. Lighting conditions and projection surfaces can be varied, too. Different camera types capture the primary display (with or without visual cues). The captured images are undistorted using the respective camera's calibration information.

For each digital data to be presented, the corresponding captured camera image, is recorded.

The recorded digital data and the captured images constitute together with the ground truth information of if (and where) the robotic arm used the cue constitute training data instances.

For each instance:
A delta-image is created by subtracting the captured, undistorted image from the data to be presented.
Each delta-image undergoes a number of standard image preprocessing steps such as

(1) de-noising, (2) sharpening, and (3) contrast improvement.
Optionally, important features are extracted from the processed delta-image
A visual object detection algorithm known from the state of the art, e.g. based on deep neural networks is trained to identify if a visual cue is present and if so, where, by comparing against the ground truth.

In an embodiment, the detection module may be trained to undistort the camera image directly, i.e. without relying on camera calibration data.

In an embodiment, an additional calibration by the actor is supported. This is beneficial as the camera and detection module and/or other system components are likely located in the venue where the presentation is held and that the actor can use a visual cue of choice. This mode may be triggered, e.g., through a button push. A test calibration image (with known image proportions and visual content) would be projected or displayed and the camera would record (for a predetermined time or until a button is pushed again). The actor uses the visual cue at his/her discretion. If recording memory does not suffice, a dedicated support device (local on premise computer, or remote/cloud server) can be used for this recording. From the recorded image, calibration information with respect to distortion, lighting conditions, and projection surface (due to knowing the ground truth test calibration image) can be learned and updated. If computation resources are limited, the calculations to update the calibration information can be performed on a remote entity (e.g. a server in the internet), which then sends back updated calibration information to the detection component 160.

During playback, all the steps involved in object detection mentioned above may be run to indicate (e.g. by a visual high-light) where cues (if any) are detected. In any playback image, the actor can: high-light undetected cues, remove high-lights in case there was an erroneously detected cue, and correct the high-light position in case a cue was correctly detected in the image but at a wrong position

The user interaction components necessary for the actor to interact can come from a conventional UI design, e.g. buttons or a computer-based interface. The actor's interaction with the playback will result in an additional training set that can be used to update the detection module. Optionally the calculations (in particular training the machine learning algorithm) to result in an update can be performed in remote entity (e.g. a server in the internet) for which the corrected playback data is sent to the remote entity. On the remote entity updating of the detection algorithm is performed; the updated detection algorithm is then sent back to the detection component.

Embodiments enable extending already existing solutions for streaming content from digital devices (e.g. laptops, smart phones) via a wireless data communication channel to a receiver in the screen (e.g. projector), e.g. using a USB dongle. One exemplary product already existing is NEC MultiPresenter, which is an application software that enables one to display a device's screen (computer, smart phone, etc.) on the receiver device (MultiPresenter Stick or projectors) via wired or wireless LAN. MultiPresenter is free and available on Windows, Mac, iOS, Android.

This embodiment replaces a video cable between the content source and the projection device. The embodiment focuses on integrating the components for visual cue detection and communication into the stick or into the display device, e.g., projector.

In one embodiment, only one main display device has the capability to detect cues, which then communicates the cues to other secondary screens for overlaying onto the content presented by the secondary display devices. That implies that the different screens (e.g. integrated in the projectors, or displays, or the corresponding USB sticks) have different capabilities i.e. there are dedicated secondary display screens. In another embodiment, more than one, or all, display devices have the capability of detecting cues and communicating them to other display devices, as well as overlaying cues based on received information from the other display devices. This has the effect that the display devices can perform both as main/primary and as secondary display devices (depending on whether they detect cues, or when they receive cue information) allowing for interactive use of laser pointers or other implements on multiple different screens of a large conferencing venue.

Embodiments of the present disclosure advantageously enable a wide range of content sources (e.g. laptops, as well as video players) due to the peer-to-peer nature of communicating detected cues directly among the display devices and not requiring content source support or the need to mix detected cues into the content stream itself (and thereby modifying the content stream).

Embodiments of the present disclosure provide for various improvements and advantages, including improving audience experience for large conference room presentations and remote presentations. Embodiments also advantageously provide novel multi-user collaboration each with its own visual cue (e.g. laser pointer) if all display devices are main/primary and secondary devices.

Embodiments also advantageously do not necessarily require a computer; some embodiments can be purely integrated into a projector and camera based setups. Cue relay becomes agnostic of dedicated cue component or presentation equipment. I.e., no proprietary cue devices or software installation on a laptop or computer is needed.

Embodiments also advantageously provide the capability to handle projection distortions and allow, e.g., for using a normal webcam or smartphone camera via software by calibration.

Embodiments also advantageously provide support for many different visual cue implements (e.g., laser pointers, fingers, pointing sticks, telescope pointing sticks, the presenter's finger's shadow, etc.).

Embodiments also advantageously provide for combining image capture and machine learning based cue detection into the main display, which improves cue detection performance by allowing for use of difference images.

Some embodiments further include a non-transitory computer-readable storage medium storing instructions that, when executed by one or more processors, perform one of the methods of simultaneously displaying an external visual cue received at a primary display device on one or more secondary display devices as described herein.

While embodiments of the disclosure have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present disclosure covers further embodiments with any combination of features from different embodiments described above and below. Additionally, statements made herein characterizing the disclosure refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for simultaneously displaying an external visual cue received at a primary display device on one or more secondary display devices in a distributed presentation system, the method comprising:
displaying original content on a primary display device;
detecting an external visual cue on the displayed original content using an external camera paired with the primary display device and configured to image the original content displayed on the primary display device;
determining one or more parameters of the external visual cue, the one or more parameters including at least a location of the external visual cue relative to the original content displayed on the primary display device; and
communicating the one or more parameters to one or more secondary display devices that are displaying the original content, to enable the one or more secondary display devices to display a representation of the external visual cue simultaneously with displaying the original content.

2. The method according to claim 1, wherein the one or more parameters further including one or more of a color of the external visual cue and a shape of the external visual cue.

3. The method according to claim 1, wherein at least one of the one or more secondary display devices is located in a location remote from the primary display device

4. The method according to claim 3, wherein the communicating includes communicating the one or more parameters to the at least one secondary device over the Internet or a wireless network.

5. The method according to claim 1, further including communicating a cue identifier with the one or more parameters, wherein the cue identifier identifies the primary display device on which the external visual cue was detected.

6. The method according to claim 1, wherein the detecting includes detecting a first appearance of the external visual cue and detecting movements of the external visual cue on the displayed original content.

7. (canceled)

8. The method according to claim 1, wherein the detecting includes:
acquiring, from the external camera, an image of a display screen of the primary display device, wherein the external visual cue is overlaying the displayed original content on the display screen; and
comparing the acquired image with the original content to identify the external visual cue.

9. The method according to claim 8, further including:
receiving one or more parameters of a second external visual cue from one of the one or more secondary display devices, the one or more parameters of the second external visual cue including at least a location of the second external visual cue relative to the displayed original content; and
displaying a representation of the second external visual cue over the original content displayed by the primary display device.

10. A visual cue detection and characterization component in a distributed presentation system that includes a primary display device that displays original content from a content source, an external camera paired with the primary display device and configured to acquire an image of the original content displayed on the primary display device, and one or more secondary display devices, each of the one or more secondary display devices displaying the original content, wherein the visual cue detection and characterization component includes one or more processors and a transceiver, wherein the visual cue detection and characterization component is configured to:
receive, using the transceiver, the image of the original content from the external camera;
process, using the one or more processors, the image of the original content to detect an external visual cue on the original content displayed on the primary display device and determine one or more parameters of the external visual cue, the one or more parameters including at least a location of the external visual cue relative to the original content displayed on the primary display device; and
communicate, using the transceiver, the one or more parameters to the one or more secondary display devices that are displaying the original content, to enable the one or more secondary display devices to display a representation of the external visual cue simultaneously with displaying the original content.

11. The detection and characterization component of claim 10,
wherein the one or more processors detect an external visual cue by comparing the image with the original content to identify the external visual cue, wherein the external visual cue is overlaying the original content displayed on the display screen.

12. The detection and characterization component of claim 10, wherein the external visual cue is overlaying the original content displayed on the display screen.

13. A non-transitory, computer-readable medium having instructions stored thereon which, after execution by one or more processors, provide for execution of a method comprising:
displaying original content on a primary display device;
detecting an external visual cue on the displayed original content using an external camera paired with the primary display device and configured to image the original content displayed on the primary display device;
determining one or more parameters of the external visual cue, the one or more parameters including at least a location of the external visual cue relative to the original content displayed on the primary display device; and
communicating the one or more parameters to one or more secondary display devices that are displaying the original content, to enable the one or more secondary display devices to display a representation of the external visual cue simultaneously with displaying the original content.

14. The non-transitory, computer-readable medium according to claim 13, wherein the external visual cue is overlaying the displayed original content on the display screen.

15. The non-transitory, computer-readable medium according to claim 13, wherein the detecting includes:
acquiring an image of a display screen of the primary display device, wherein the external visual cue is overlaying the displayed original content on the display screen; and
comparing the acquired image with the original content to identify the external visual cue.
